(19) United States
(12) Patent Application Publication
(10) Pub. No.: US 2024/0004323 A1
(43) Pub. Date: Jan. 4, 2024

(54) ELECTROPHOTOGRAPHIC PHOTORECEPTOR, IMAGE FORMING APPARATUS AND IMAGE FORMING METHOD

(71) Applicant: Konica Minolta, Inc., Tokyo (JP)

(72) Inventors: Toshiyuki FUJITA, Tokyo (JP); Kazukuni Nishimura, Tokyo (JP)

(21) Appl. No.: 18/337,788

(22) Filed: Jun. 20, 2023

(30) Foreign Application Priority Data
Jul. 4, 2022 (JP) 2022-107690

(51) Int. Cl. G03G 8/00; G03G 15/02; G03G 15/16; G03G 7/00

(52) U.S. Cl. CPC G03G 8/00; G03G 15/0216; G03G 15/162; G03G 7/0046; G03G 7/0013

(57) ABSTRACT

Provided is an electrophotographic photoreceptor capable of reducing the rotational torque of the photoreceptor and also reducing the increase in the rotational torque during long-term use when a cured layer obtained by curing a charge transporting compound having a radically polymerizable group is used as a protective layer. In the electrophotographic photoreceptor, a conductive support, a photosensitive layer, and a protective layer are laminated in this order. The protective layer is formed of a cured product of a composition containing the following: a charge transporting compound having a radically polymerizable functional group; and metal oxide particles surface-treated with a surface treating agent having a silicone chain in a side chain thereof.

### CROSS REFERENCE TO RELATED APPLICATIONS

The entire disclosure of Japanese Patent Application No. 2022-107690 filed on Jul. 4, 2022, is incorporated herein by reference in its entirety

### BACKGROUND

### Technological Field

The present invention relates to an electrophotographic photoreceptor, an image forming apparatus, and an image forming method.

### Description of Related Art

An electrophotographic photoreceptor (hereinafter also referred to simply as a “photoreceptor”) is used in an electrophotographic image forming apparatus to form an electrostatic latent image corresponding to an image to be formed. In an electrophotographic image forming apparatus, first, a photoreceptor having a charged surface is irradiated with light to form an electrostatic latent image. Then, toner is supplied to the photoreceptor to form a toner image corresponding to the electrostatic latent image. Finally, the toner image is transferred and fixed to a recording medium such as paper.

From the photoreceptor, residual toner that is not transferred and remains on the surface of the photoreceptor is removed with a cleaning blade or the like (cleaning is performed). Since the surface of the photoreceptor is abraded by this cleaning, the photoreceptor needs to be replaced periodically. In contrast, there is a demand for improving abrasion resistance of a photoreceptor to prolong its life and reduce the frequency of replacement.

It is known that the abrasion resistance of a photoreceptor can be improved by using a cured layer obtained by a curing reaction of a charge transporting compound having a radically polymerizable group as a protective layer located on the outermost layer (for example, Japanese Unexamined Patent Publication No. 2014-105223).

According to the findings of the present inventors, when a cured layer obtained by subjecting a charge transporting compound having a radically polymerizable group to a cure reaction as described in Japanese Unexamined Patent Publication No. 2014-105223 is used as a protective layer, the friction with a cleaning blade increases, and the rotational torque of the photoreceptor tends to increase. In addition, the rotational torque of the photoreceptor increases during long-term use.

### SUMMARY

An object of the present invention is to provide an electrophotographic photoreceptor capable of reducing the rotational torque of the photoreceptor and also reducing the increase in the rotational torque during long-term use when a cured layer obtained by curing a charge transporting compound having a radically polymerizable group is used as a protective layer. It is another object of the present invention to provide an image forming apparatus including the electrophotographic photoreceptor, and an image forming method using the electrophotographic photoreceptor.

In order to achieve at least one of the above-described objects, an electrophotographic photoreceptor reflecting an aspect of the the present invention includes a conductive support, a photosensitive layer, and a protective layer, which are laminated in this order. The protective layer is formed of a cured product of a composition containing a charge transporting compound and a metal oxide particle, the charge transporting compound having a radically polymerizable functional group, the metal oxide particle being surface-treated with a surface treating agent having a silicone chain in a side chain thereof.

### BRIEF DESCRIPTION OF DRAWINGS

The advantageous and features provided by one or more embodiments of the invention will become more fully understood from the detailed description given hereinbelow and the appended drawings which are given by way of illustration only, and thus are not intended as a definition of the limits of the present invention:

FIG. 1 is a partial cross-sectional view illustrating an exemplary layer configuration of an electrophotographic photoreceptor according to an embodiment of the present invention; and

FIG. 2 schematically illustrates a configuration of an image forming apparatus according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

1. Electrophotographic Photoreceptor

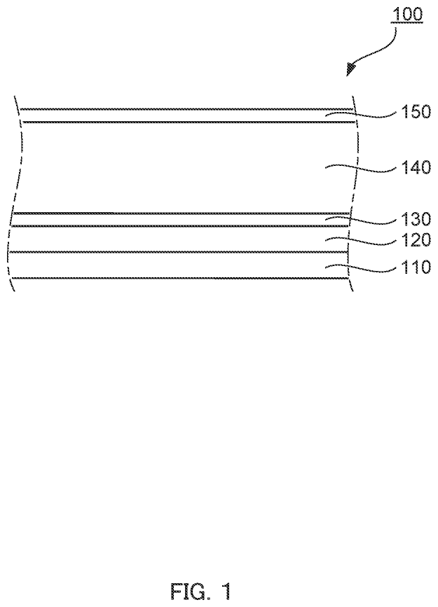

FIG. 1 is a partial cross-sectional view illustrating an exemplary layer configuration of an electrophotographic photoreceptor 100 according to an embodiment of the present invention. The photoreceptor 100 according to the present embodiment includes a conductive support 110, an intermediate layer 120, a charge generation layer 130, a charge transport layer 140, and a protective layer 150 which are laminated in this order.

1-1. Conductive Support 110

The conductive support 110 is a member that supports the intermediate layer 120, the charge generation layer 130, the charge transport layer 140, and the protective layer 150. The conductive support 110 has conductivity at least on the surface thereof contacting the intermediate layer 120. Examples of the conductive support 110 include a metal drum or sheet; a plastic film having a laminated metal foil; a plastic film having a layer of a vapor-deposited conductive material; and a metal member, a plastic film, or paper each having a conductive layer formed by application of a conductive material or a coating material containing a conductive material and a binder resin. Examples of the metal include aluminum, copper, chromium, nickel, zinc, and stainless steel. Examples of the conductive material include the above metal, indium oxide, and tin oxide. The metal is preferably aluminum from the viewpoint of improving the processability and the robustness of the conductive support 110 and reducing the weight of the conductive support 110. The circumferential wall of the conductive support 110 may be about 0.1 mm thick, for example.

1-2. Intermediate Layer 120

The intermediate layer 120 is disposed between the conductive support 110 and the charge generation layer 130. The intermediate layer 120 is a layer having a function of removing charges (typically, electrons) from the charge generation layer 130 to the conductive support 110 side, a function of suppressing leakage of charges (typically, holes) from conductive support 110 to the charge generation layer 130, an adhesion function, and the like. The intermediate layer 120 contains a binder resin for the intermediate layer and conductive particles.

Examples of the binder resin for the intermediate layer include polyamide resin, casein, polyvinyl alcohol resin, nitrocellulose, ethylene-acrylic acid copolymers, vinyl chloride resin, vinyl acetate resin, polyurethane resin, and gelatin. One of these binder resins for the intermediate layer may be used, or two or more thereof may be used.

Examples of the particle body of the conductive particles include metal oxide particles of aluminum oxide (alumina), aluminum hydroxide, zinc oxide, titanium oxide, tin oxide, antimony oxide, zirconium oxide, indium oxide, and bismuth oxide; and particles of conductive materials such as tin-doped indium oxide, antimony-doped tin oxide, and zirconium oxide. From the viewpoint of further enhancing the removability of charges to the conductive support side in the intermediate layer 120, the conductive material is preferably an N-type semiconductor. Examples of the conductive material as the n-type semiconductor include titanium oxide, zinc oxide, aluminum oxide, aluminum hydroxide, and tin oxide. From the viewpoint of enhancing the conductivity of the intermediate layer 120 and enhancing the dispersibility of the conductive particles in intermediate layer 120, the conductive material is preferably titanium oxide, tin oxide, or zinc oxide, and more preferably titanium oxide. The crystal form of the titanium oxide may be an anatase form, a rutile form, or an amorphous form. The crystal form of the titanium oxide may be of one type or more types.

The content of the conductive particle is, for example, preferably 50 parts by volume or more and 200 parts by volume or less, more preferably 80 parts by volume or more and 120 parts by volume or less with respect to 100 parts by volume of the binder resin in the intermediate layer.

1-3. Charge Generation Layer 130

Charge generation layer 130 contains, for example, a binder resin for the charge generation layer and a charge generation material dispersed in the binder resin for the charge generation layer.

Examples of the binder resin for the charge generation layer include formal resin, butyral resin, polystyrene resin, polyethylene resin, polypropylene resin, acrylic resin, methacrylic resin, vinyl chloride resin, vinyl acetate resin, polyvinyl butyral resin, epoxy resin, polyurethane resin, phenolic resin, polyester resin, alkyd resin, polycarbonate resin, silicone resin, silicone-modified butyral resin, phenoxy resin, melamine resin, copolymer resin containing two or more of these resin (for example, vinyl chloride-vinyl acetate copolymer resin, vinyl chloride-vinyl acetate-maleic anhydride copolymer resin, and the like), and polyvinyl carbazole resin. One of these binder resins for the charge generation layer may be used, or two or more thereof may be used.

Examples of the charge generation material for the charge generation layer include azo raw materials including Sudan Red, Dian Blue, and the like; quinone pigments including pyrenequinone, anthanthrone, and the like; quinocyanine pigments; perylene pigments; indigo pigments including indigo, thioindigo, and the like; polycyclic quinone compounds such as pyranthrone and diphthaloylpyrene; and phthalocyanine pigments. One of these charge generation material for the charge generation layer may be used, or two or more thereof may be used.

The phthalocyanine pigment may contain a core metal. Examples of the contain a core metal include Ti, Fe, V, Si, Pb, Al, Zn, and Mg. One of these core metals may be used, or two or more thereof may be used. In view of increasing the sensitivity of the charge generation layer, the phthalocyanine pigment is preferably a titanyl phthalocyanine compound having Ti as the core metal. Further, in X-ray diffraction by CuKα ray, the titanyl phthalocyanine compound is preferably, from the same viewpoint, a Y-type titanyl phthalocyanine compound (having the largest peak at a Bragg angle (2θ±0.2) of 27.3° and having distinct diffraction peaks at 7.4°, 9.7°, and 24.2°), 2,3-butanediol adduct titanyl phthalocyanine (having distinct diffraction peaks at Bragg angles of 8.3°, 24.7°, 25.1°, and 26.5°), or the like.

The content of the charge generation material is preferably 20 parts by mass or more and 600 parts by mass or less, and more preferably 50 parts by mass or more and 500 parts by mass or less, with respect to 100 parts by mass of the binder resin for the charge generation layer. The charge generation layer in which the content of the charge generation material is within the range described above has an increased dispersibility of the charge generation material, and thus, the electric resistance of the charge generation layer is easily reduced, and an increase in a remaining charge accompanying the use of the photoreceptor can be further suppressed.

The charge generation layer 130 is prepared by, for example, a dip coating method in which the conductive support, on which the intermediate layer 120 is formed, is immersed in a solution (in which a charge generation material is dispersed) of a binder resin for a charge generation layer.

The thickness of the charge generation layer 130 may be, for example, 0.01 μm or more and 5 μm or less, preferably 0.05 μm or more and 3 μm or less, more preferably 0.05 μm or more and 2 μm or less, and further more preferably 0.15 μm or more and 1.5 μm or less.

1-4. Charge Transport Layer 140

The charge transport layer 140 contains, for example, a binder resin for the charge transport layer and a charge transport material dispersed in the binder resin for the charge transport layer.

The binder resin for the charge transport layer is a thermoplastic resin or a thermosetting resin. Examples of the binder resin for the charge transport layer include polystyrene, acrylic resin, methacrylic resin, vinyl chloride resin, vinyl acetate resin, polyvinyl butyral resin, epoxy resin, polyurethane resin, phenolic resin, polyester resin, alkyd resin, polycarbonate resin, silicone resin, and melamine resin. The binder resin for the charge transport layer may be a copolymer containing two or more types of repeating unit structures of the above binder resins for the charge transport layer. Among these, the binder resin for the charge transport layer is preferably a polycarbonate resin having a low water absorption rate and a high mechanical strength.

Examples of the charge transporting material include triphenylamine derivatives, hydrazone compounds, styryl compounds, benzidine compounds, and butadiene compounds. One of these charge transport materials may be used, or two or more thereof may be used.

The content of the charge transport material is preferably 10 parts by mass or more and 200 parts by mass or less with respect to 100 parts by mass of the binder resin for the charge transport layer.

The charge transport layer 140 is prepared by, for example, a dip coating method in which the conductive support, on which the charge generation layer is formed, is immersed in a solution (in which the charge transport material is dispersed) of a binder resin for the charge transport layer. In addition, the charge transport layer 140 is produced, for example, by applying a solution (in which the charge transport material is dispersed) of the binder resin for the charge transport layer on the surface of the charge generation layer 130, and drying the solution.

The thickness of the charge transport layer 140 may be, for example, 5 μm or more and 40 μm or less. From the viewpoint of strengthening the internal electric field of the photoreceptor 100 and suppressing an increase in residual charge associated with the use of the photoreceptor 100, the thickness of the charge transport layer 140 is preferably 10 μm or more and 40 μm or less and more preferably 10 μm or more and 30 μm or less. The thickness of the charge transport layer 140 can be appropriately adjusted depending on the type of the binder resin for the charge transport layer 140 and the type and content of the charge transport material.

The charge generation layer 130 and the charge transport layer 140 may be configured as a single-layer photosensitive layer. The photosensitive layer may be formed of a single-layered material containing a binder resin for the photosensitive layer, the charge transport material, and the charge generation material. The thickness of the single-layered photosensitive layer may be, for example, 10 μm or more and 50 μm or less, preferably 20 μm or more and 40 μm or less.

Examples of the binder resin for the photosensitive layer constituting the single-layered photosensitive layer include polystyrene resin, polyethylene resin, polypropylene resin, acrylic resin, methacrylic resin, vinyl chloride resin, vinyl acetate resin, polyvinyl butyral resin, epoxy resin, polyurethane resin, phenolic resin, polyester resin, alkyd resin, polycarbonate resin, silicone resin, melamine resin, copolymer resin containing two or more of these resins (for example, vinyl chloride-vinyl acetate copolymer resin and vinyl chloride-vinyl acetate-maleic anhydride copolymer resin), polyvinyl carbazole resin, polyacrylate resin, styrene-acrylonitrile copolymer resin, polymethacrylate resin, and styrene-methacrylate copolymer resin.

1-5. Protective Layer 150

The protective layer is a layer for protecting the charge generation layer 130 and the charge transport layer 140 (photosensitive layer). The protective layer 150 is disposed on the surface side of the charge transport layer 140 (photosensitive layer) and forms the surface of the photoreceptor 100. The protective layer 150 includes a binder resin for the protective layer and metal oxide particles for the protective layer.

In the present embodiment, in protective layer 150, the binder resin for the protective layer is formed of a cured product of a composition containing a charge transporting compound and metal oxide particles. The charge transporting compound has a radically polymerizable functional group, and the metal oxide particles are surface-treated with a surface treating agent having a silicone chain in a side chain thereof.

In the cured product, the metal oxide particles are further surface-treated with a surface treating agent having a silicone chain in a side chain thereof. The surface treating agent having a silicone chain in a side chain thereof is more likely to align the silicone chain to the outside of the metal oxide fine particle. The surface treating agent is more likely to expose the silicone chain, which is oriented outward from the metal oxide fine particle at the outermost layer of the cured product, to the outside from the surface of the cured product. The surface treating agent having a silicone chain in a side chain can reduce the friction with the cleaning blade by the silicone chain exposed to the outside from the surface of the cured product (protective layer 150), thereby reducing the rotational torque of the photoreceptor 100.

In addition, the silicone chain oriented outward from the metal oxide fine particle can increase the compatibility between the charge transporting compound having a radically polymerizable functional group and the metal oxide fine particle in the composition before curing. Thus, the metal oxide fine particles are more likely to be uniformly dispersed in the composition and more likely to be uniformly placed in the cured product, so that the silicone chain is also more likely to be uniformly exposed to the outside from the surface of the cured product. Therefore, the surface treating agent having a silicone chain in the side chain can effectively reduce the rotational torque of protective layer 150.

Furthermore, since the compatibility between the charge transporting compound having a radically polymerizable functional group and the metal oxide fine particles is high, the charge transporting compound having a radically polymerizable functional group is also more likely to be uniformly dispersed in the composition. Thus, the charge transporting compound having the uniformly dispersed radically polymerizable functional group is more likely to meet another polymerizable compound during curing, effectively causing a reaction between molecules. According to this, the surface treating agent having a silicone chain in a side chain is less likely to generate an unreacted polymerizable compound, and it is possible to suppress an increase in rotational torque due to the unreacted polymerizable compound.

On the other hand, since the silicone chain has high bond energy in the chain, deterioration due to discharge for charging the photoreceptor 100, an oxide (discharge product) generated by the discharge, or the like is less likely to occur. Therefore, the surface treating agent having a silicone chain in a side chain makes the metal oxide, which is originally resistant to deterioration, further resistant to deteriorate, and can reduce the increase in rotational torque during long-term use.

In addition, as described above, an unreacted polymerizable compound is less likely to be generated in the cured product constituting the protective layer 150. Therefore, the cured product is less likely to deteriorate due to an unexpected reaction of the functional group of the unreacted polymerizable compound during use, and the rotational torque is less likely to increase during long-term use. Furthermore, the cured product is less likely to cause image deletion during use in a high-temperature and high-humidity environment due to a reaction between the functional group of the unreacted polymerizable compound and the discharge product.

Whether the protective layer 150 is formed of a cured product of a composition containing a charge transporting compound having a radically polymerizable functional group can be determined by measuring and analyzing an alkali hydrolyzate of the protective layer 150 by a known method such as NMR, IR, or mass spectrometry.

In addition, whether the protective layer 150 is formed of a cured product of a composition containing metal oxide particles surface-treated with a surface treating agent having a silicone chain in a side chain can be confirmed by a method of observing a cross section of the protective layer 150 with a scanning electron microscope (SEM) and performing molecular mapping of a captured cross-sectional image, or the like.

1-5-1. Charge Transporting Compound Having Radically Polymerizable Functional Group

The charge transporting compound having a radically polymerizable functional group can suppress, due to the charge transporting structure, the occurrence of image memory. On the other hand, by having a radically polymerizable functional group, the charge transport material can be incorporated into the polymer chain during curing, thereby suppressing desorption, which would be caused by friction of the charge transporting structure, and enhancing the rub resistance of protective layer 150. The charge transporting compound having a radically polymerizable functional group may be any compound having a charge transporting functional group and a radically polymerizable functional group.

The charge transporting functional group may be a functional group having a known charge transporting structure such as a structure having a π-conjugated moiety. From the viewpoint of increasing the compatibility with the metal oxide particles surface-treated with a surface treating agent having a silicone chain in a side chain, the charge transporting functional group preferably has a small molecular size of a π-conjugated moiety.

The radically polymerizable functional group may be any known radically polymerizable functional group such as a vinyl group or a (meth)acryloyl group, and is preferably a (meth)acryloyl group. In the present specification, (meth)acryloyl means either one or both of acryloyl and methacryloyl. The charge transporting compound having a radically polymerizable functional group preferably has one or two of the radically polymerizable functional groups in the molecule thereof, and more preferably has one of the radically polymerizable functional groups in the molecule.

Examples of the charge transporting compound having a radically polymerizable functional group having such a characteristic include compounds represented by the following General Formula (1).

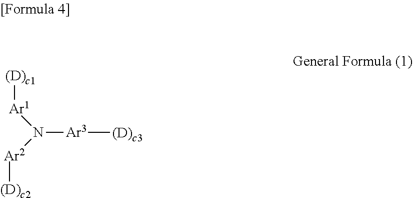

In General Formula (1), Ar¹ and Ar² independently represent a structure represented by General Formula (2), and Ar³ represents a structure represented by General Formula (2) or General Formula (3).

In General Formula (1), D independently represents a structure represented by —(—(CH₂)_{d}—(O—(CH₂)_{f}—)ₑ—O—CO—C(CH₃)═CH₂) or —(—(CH₂)_{d}—(O—(CH₂)_{f})ₑ—O—CO—CH═CH₂).

Herein, d and f independently represent an integer of 0 or more and 5 or less. It is preferable that d and f are integers of 1 or more and 4 or less.

Herein, e represents an integer of 0 or 1. It is preferable that e is 1. In particular, a compound in which the total of c1 to c3 is 1, e represents 1, and at least one of d or f represents an integer of 1 or more and 4 or less can be more favorably dispersed. It is considered that the compound has a structure having a relatively long chain such as an alkyl chain or an alkylene oxide chain, and thus has high compatibility with other materials at the time of production, thereby improving dispersibility. In addition, during curing, the polymerizable group (D) is more likely to move due to the relatively long chain, and thus the curing reaction easily proceeds. Due to these effects, the compound enhances the stability of the cured product and is less likely to remain unreacted, and thus the increase in the rotational torque during long-term use can be reduced, and image deletion during use in a high-temperature and high-humidity environment can also be suppressed.

Herein, c1 to c3 independently represents an integer of 0, 1, or 2. In a case where Ar³ represents the structure represented by General Formula (2), the total number of D's in the compound is 1 or 2, and in a case where Ar³ represents the structure represented by General Formula (3), the total number of D's in the compound is 1.

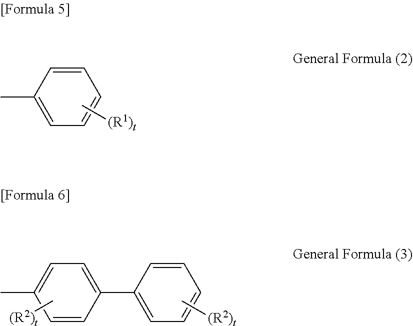

In General Formulas (2) and (3), R¹ and R² independently represent a functional group or an atom selected from the group consisting of a hydrogen atom, an alkyl group having 1 or more and 4 or less carbon atoms, an alkoxy group having 1 or more and 4 or less carbon atoms, a phenyl group substituted with an alkoxy group having 1 or more and 4 or less carbon atoms, an unsubstituted phenyl group, an aralkyl group having 7 or more and 10 or less carbon atoms, and a halogen atom. In General Formula (3), two R² may be bonded to each other to form a cyclic structure. Among those, an alkyl group having 1 or more and 4 or less carbon atoms is preferable, and the methyl group is more preferable.

In General Formulas (2) and (3), t independently represents an integer of 1 or more and 3 or less, is preferably 1 or 2, and more preferably 1.

Among the compounds represented by General Formula (1), examples of the compound in which the total number of D's in the compound is 1 include the following compounds.

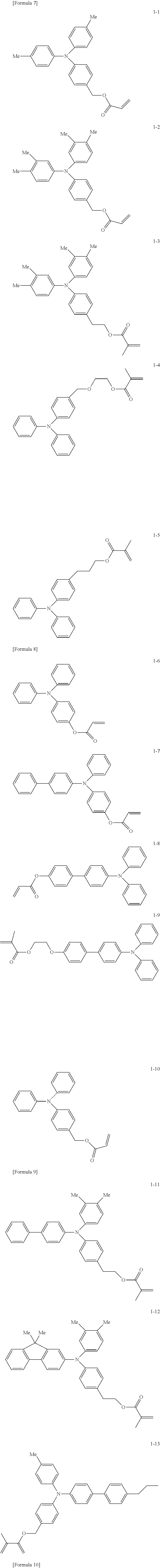

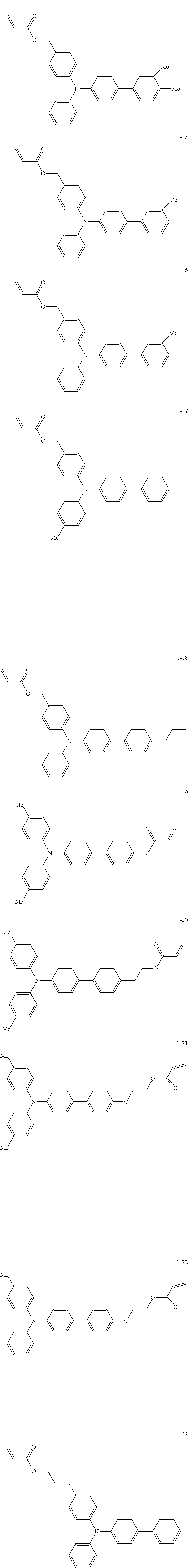

Among the compounds represented by General Formula (1), examples of the compound in which the total number of D's in the compound is 2 include the following compounds.

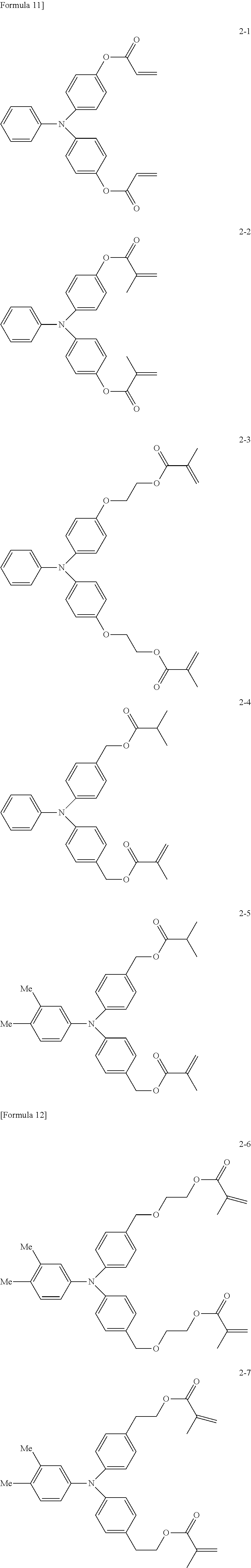

1-5-2. Metal Oxide Particles Surface-Treated with Surface Treating Agent Having Silicone Chain in Side Chain

The metal oxide particles surface-treated with the surface treating agent having a silicone chain in a side chain can appropriately adjust the electrical resistance of protective layer 150 to enhance the image quality stability and the abrasion resistance of protective layer 150.

The metal oxide constituting the metal oxide particles is an oxide of a metal or a metalloid (in the present specification, the oxides of a metal and a metalloid are collectively referred to as a “metal oxide”). Examples of the metal oxide include silica (silicon dioxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide, tin-doped indium oxide, and antimony-doped tin oxide and zirconium oxide. One of these metal oxide particles may be used, or two or more thereof may be used. When two or more types of metal oxide particles are used, the metal oxide particles may be in the form of a solid solution or a fused body. Among these, silica and tin oxide are preferable from the viewpoint of increasing the hardness of the protective layer 150 to increase the abrasion resistance, securing the light transmittance of the protective layer, and suppressing the deterioration of electrical characteristics during long-term use in a low-humidity and low-temperature environment.

The number-average primary particle diameter of the metal oxide particles may be, for example, 1 nm or more and 300 nm or less, and is preferably 3 nm or more and 100 nm or less. The number-average primary particle diameter of the metal oxide particles can be measured by the same method as the number-average primary particle diameter of the metal oxide particles for an intermediate layer.

The number-average primary particle diameter of the metal oxide particles can be measured, for example, by the following method. A 10,000 times magnified photograph taken by a scanning electron microscope (manufactured by JEOL Ltd. or the like) is taken into a scanner. From the resulting photographic image, 300 particle images, with images of aggregated particles excluded, are randomly subjected to binarization processing using an automatic image processing analysis system “LUZEX AP” (manufactured by NIRECO Corporation, “LUZEX” is a registered trademark of the company, software Ver. 1.32) or the like to calculate the horizontal Feret diameter of each particle image. An average value of the calculated horizontal Feret diameters is calculated and used as the number average primary particle diameter of the metal oxide particles. Herein, the horizontal Feret diameter refers to the length of a side, parallel to the x-axis, of a circumscribed rectangle obtained by binarizing the particle images.

The content of the metal oxide particles is, for example, preferably 1 part by mass or more and 100 parts by mass or less, more preferably 5 parts by mass or more and 80 parts by mass or less, with respect to 100 parts by mass of the binder resin. As the content of the metal oxide particles is increased, the hardness of protective layer 150 is increased, and the abrasion resistance is further increased. When the content of the metal oxide particles is not excessive, it is possible to easily form a latent image with high resolution by securing light transmittance, thereby allowing image defects due to aggregation of the metal oxide particles to less likely to occur.

The metal oxide particles are surface-treated with a surface treating agent having a silicone chain in a side chain. The surface treating agent is a surface treating agent having a polymer main chain, a surface treating functional group, and a side chain including a silicone chain.

The main chain of the polymer may be a main chain of a (meth)acrylic copolymer or a silicone chain.

The surface treating functional group may be a carboxyl group, a hydroxyl group, an alkoxysilyl group, or the like.

The side chain including a silicone chain preferably has a dimethylsiloxane structure as a repeating unit. The number of dimethylsiloxane structures as a repeating unit is preferably 3 or more and 100 or less, more preferably 3 or more and 50 or less, and further more preferably 3 or more and 30 or less, per side chain.

In a case where the main chain of the polymer is a silicone chain, it is preferable that the silicone chain as the main chain of the polymer also has the same structure.

The surface treating agent having a silicone chain in a side chain preferably has a number average molecular weight of 1,000 or more and 300,000 or less.

Examples of commercially available products of the surface treating agent having a main chain formed of a (meth)acrylic copolymer and a side chain including a silicone chain include SYMAC US-350 (manufactured by Toagosei Co., Ltd., “SYMAC” is a registered trademark of the company), and KP-541, KP-574, and KP-578 (all manufactured by Shin-Etsu Chemical Co., Ltd.).

Examples of commercially available products of the surface treating agent having a main chain formed of a silicone chain and a side chain including a silicone chain include KF-9908 and KF-9909 (both manufactured by Shin-Etsu Chemical Co., Ltd.).

Only one surface treating agent having a silicone chain in a side chain may be used, or two or more surface treating agents may be used in combination.

The treatment amount of the surface treating agent having a silicone chain in a side chain with respect to the metal oxide particles is, for example, preferably 1 part by mass or more and 10 parts by mass or less, more preferably 3 parts by mass or more and 7 parts by mass or less, with respect to 100 parts by mass of the metal oxide particles. The treatment amount can be appropriately adjusted depending on the number average primary particle diameter of the metal oxide particles and the type of the surface treating agent.

The metal oxide particle preferably has a radically polymerizable functional group. The radically polymerizable functional group increases compatibility between the metal oxide fine particle and the polymerizable compound, and thus makes it easier to disperse the metal oxide fine particle more uniformly in the composition. Thus, the abrasion resistance of protective layer 150 is more effectively enhanced, and the effects due to the above-described effects, such as reducing torque, suppressing an increase in rotational torque, and suppressing image deletion in a high-temperature high-humidity environment, are also more effectively enhanced. For example, the metal oxide particle is preferably surface-modified with a surface modifier having a radically polymerizable functional group.

The surface modifier may be a surface modifier capable of reacting with a functional group (hydroxyl group) or the like located on the surface of the metal oxide particle, for example, a surface modifier having a radically polymerizable functional group among silane coupling agents and titanium coupling agents.

Examples of such a surface modifier include a silane coupling agent having a (meth)acryloyl group.

Examples of the silane coupling agent having a (meth)acryloyl group include the following compounds.

CH₂═CHSi(CH₃)(OCH₃)₂ S-1:

CH₂═CHSi(OCH₃)₃ S-2:

CH₂═CHSi(OC₂H₅)₃ S-3:

CH₂═CHCH₂Si(OCH₃)₃ S-4:

CH₂═CHCH₂Si(OC₂H₅)₃ S-5:

CH₂═CHCOO(CH₂)₂Si(CH₃)(OCH₃)₂ S-6:

CH₂═CHCOO(CH₂)₂Si(OCH₃)₃ S-7:

CH₂═CHCOO(CH₂)₃Si(OCH₃)₃ S-8:

CH₂═CHCOO(CH₂)₃Si(OC₂H₅)₃ S-9:

CH₂═CHCOO(CH₂)₃Si(CH₃)(OCH₃)₂ S-10:

CH₂═CHCOO(CH₂)₃SiCl₃ S-11:

CH₂═CHCOO(CH₂)₃Si(CH₃)Cl₂ S-12:

CH₂═C(CH₃)COO(CH₂)₂Si(CH₃)(OCH₃)₂ S-13:

CH₂═C(CH₃)COO(CH₂)₂Si(OCH₃)₃ S-14:

CH₂═C(CH₃)COO(CH₂)₃Si(CH₃)(OCH₃)₂ S-15:

CH₂═C(CH₃)COO(CH₂)₃Si(OCH₃)₃ S-16:

CH₂═C(CH₃)COO(CH₂)₃Si(OC₂H₅)₃ S-17:

CH₂═C(CH₃)COO(CH₂)₃Si(CH₃)Cl₂ S-18:

CH₂═C(CH₃)COO(CH₂)₃SiCl₃ S-19:

CH₂═C(CH₃)COO(CH₂)₈Si(OCH₃)₃ S-20:

The surface modifier is not limited to the above-described compounds, and may be a silane compound having a radically polymerizable functional group.

Only one surface modifier having a radically polymerizable functional group may be used, or two or more of the surface modifiers may be used in combination.

The treatment amount of the surface treating agent with respect to the metal oxide particles for a protective layer is, for example, preferably 0.1 parts by mass or more and 100 parts by mass or less with respect to 100 parts by mass of the metal oxide particles for a protective layer. The treatment amount can be appropriately adjusted depending on the number average primary particle diameter of the metal oxide particles and the type of the surface treating agent.

The treatment of the metal oxide with the surface treating agent having a silicone chain in a side chain (and the surface modifier having a radically polymerizable functional group) can be performed by the following method. First, a slurry (a suspension of solid particles) containing metal oxide particles and the surface treating agent (and surface modifier) is wet-pulverized to reduce the size of the metal oxide particles, and at the same time, the surface treatment (and surface modification) of the particles proceeds. Thereafter, the solvent is removed to obtain powder.

The slurry is preferably a mixture of 0.1 to 100 parts by mass of the surface treating agent (and the surface modifier) and 50 to 5,000 parts by mass of the solvent with respect to 100 parts by mass of the metal oxide particles.

The wet pulverization of the slurry can be performed by a known wet media dispersion type apparatus. The wet media dispersion type apparatus is an apparatus performing a process in which a container is filled with beads as media, and a stirring disc vertically attached to a rotation axis is further rotated at a high speed to crush to pulverize/disperse aggregated particles of metal oxide particles. The wet media dispersion type apparatus may be any of a vertical type, a horizontal type, a continuous type, a batch type and the like. Examples of the wet media dispersion type apparatus include sand mills, ultra-visco mills, pearl mills, grain mills, dyno mills, agitator mills, and dynamic mills.

As beads used in such a wet media dispersion type apparatus, balls made of glass, alumina, zircon, zirconia, steel, flint stone, or the like can be used. Among these, zirconia and zircon are preferable. The size of the beads is usually about 1 to 2 mm in diameter, but in the present embodiment, from the viewpoint of effectively performing surface treatment (and surface modification), it is preferable to use beads of about 0.1 to 1.0 mm in diameter.

The disk and the inner wall of the container of the wet media dispersion type apparatus may be made of stainless steel, nylon, ceramic, or the like. In the present embodiment, from the viewpoint of effectively performing the surface treatment (and surface modification), a disk and an inner wall of the container made of ceramic, such as zirconia and silicon carbide, are preferable.

1-5-3. Other Components

The other components may be contained in protective layer 150 as necessary. Examples of the other components include polymerizable compounds (excluding charge transporting compounds having a radically polymerizable functional group and metal oxide fine particles surface-modified with a surface treating agent having a silicone chain in a side chain and a surface modifier having a radically polymerizable functional group), polymerization initiators (or residues thereof), lubricant particles, and antioxidants.

The polymerizable compound may be a known radically polymerizable compound.

The radically polymerizable compound preferably has two or more radically polymerizable functional groups. In addition, the radically polymerizable functional group is preferably a (meth)acryloyl group. Examples of the radically polymerizable compound having a (meth)acryloyl group include compounds represented by the following Formulae M1 to M15.

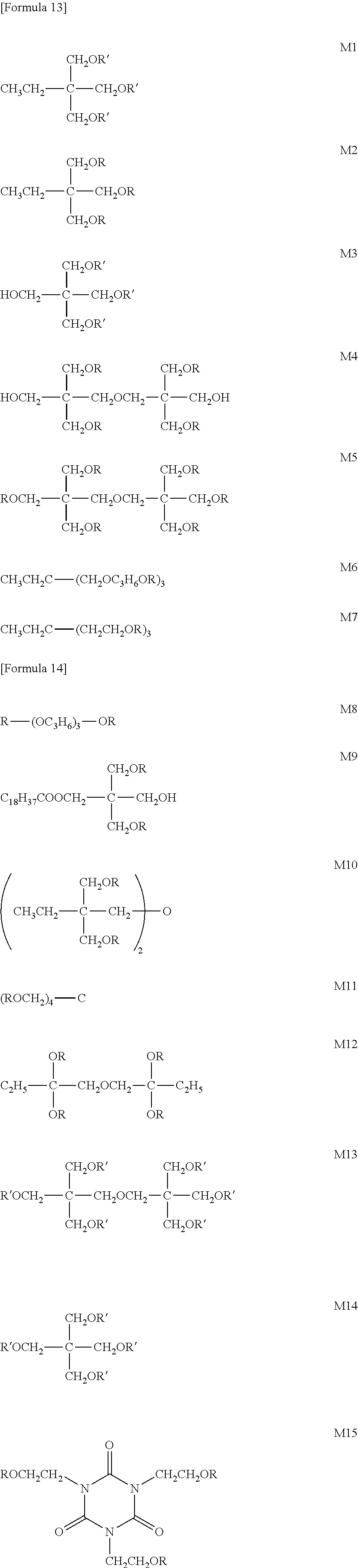

In the formulae M1 to M15, R represents an acryloyl group, and R′ represents a methacryloyl group.

Examples of the lubricant particles include fluororesin particles. Examples of the fluororesin constituting the fluororesin particles include tetrafluoroethylene resin, trifluorochloroethylene resin, hexafluorochloroethylenepropylene resin, vinyl fluoride resin, vinylidene fluoride resin, difluorodichloroethylene resin, and copolymers thereof. The fluororesin is preferably a tetrafluoroethylene resin or a vinylidene fluoride resin. One of these lubricant particles may be used, or two or more thereof may be used.

The number average primary average particle diameter of the lubricant particles is preferably 0.01 μm or more and 1 μm or less, more preferably 0.05 μm or more and 0.5 μm or less.

The content of the lubricant particles is preferably 5 parts by mass or more and 70 parts by mass or less, more preferably 10 parts by mass or more and 60 parts by mass or less, with respect to 100 parts by mass of the binder resin for a protective layer.

The thickness of the protective layer 150 is, for example, preferably 0.2 μm or more and 10 μm or less, more preferably 0.5 μm or more and 6 μm or less, further preferably 1.5 μm or more and 5.0 μm or less.

Protective layer 150 can be prepared by the following method. First, a composition containing the above-described charge transporting compound having a radically polymerizable functional group and metal oxide particles surface-treated with the above-described surface treating agent having a silicone chain in a side chain is applied to a photosensitive layer. Next, the applied composition is cured by irradiation with ultraviolet rays or electron beams. The composition may optionally include a polymerization initiator and the above-described other components. In a case where the composition is cured by irradiation with electron beams, it is not necessary for the composition to include a polymerization initiator.

The polymerization initiator may be a thermal polymerization initiator or a photopolymerization initiator, but is preferably a photopolymerization initiator. In addition, the polymerization initiator is preferably a radical polymerization initiator.

Examples of the radical polymerization initiator include alkylphenone-based compounds and phosphine oxide-based compounds.

The polymerization initiator is preferably a compound having an α-aminoalkylphenone structure or an acylphosphine oxide structure, and more preferably a compound having an acylphosphine oxide structure.

Examples of the compound having an acyl phosphineoxide structure include IRGACURE 819 (bis(2,4,6-trimethylbenzoyl)phenylphosphine oxide) (manufactured by IGM Resins B. V, “IRGACURE” is a registered trademark of BASF SE).

Only one polymerization initiator may be used, or two or more polymerization initiators may be used in combination.

The content of the polymerization initiator in the composition is preferably in a range of 0.1 parts by mass or more and 20 parts by mass or less, more preferably 0.5 parts by mass or more and 10 parts by mass or less, with respect to 100 parts by mass of the polymerizable compound.

2. Image Forming Apparatus and Image Forming Method

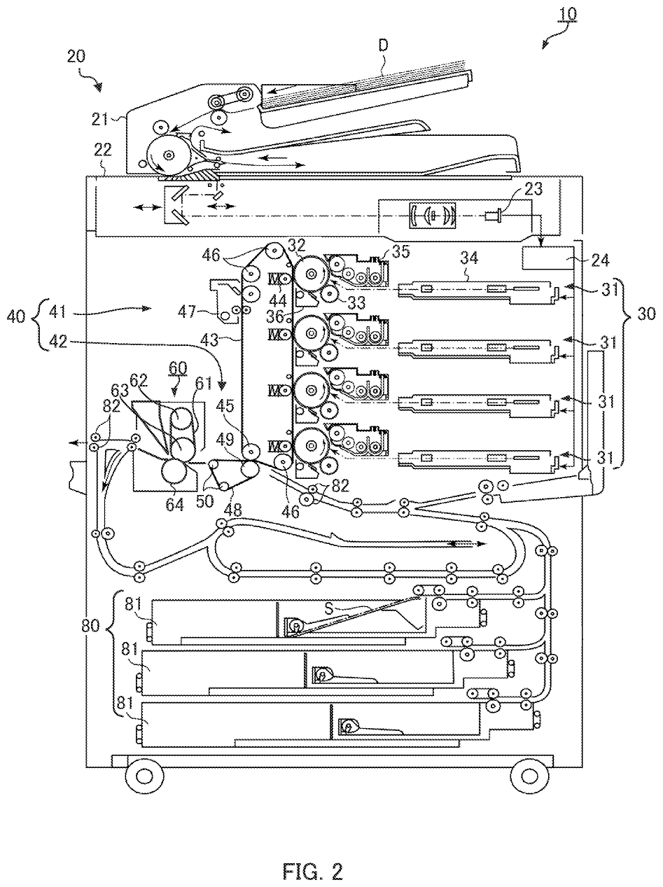

FIG. 2 schematically illustrates a configuration of an image forming apparatus according to an embodiment of the present invention. The image forming apparatus 10 includes an image reading section 20, an image forming section 30, an intermediate transfer section 40, a fixing device 60, and a recording medium conveying section 80. The configuration of the image forming apparatus 10 is the same as that of a known image forming apparatus except for the photoreceptor 32.

The image reading section 20 reads an image from a document D and obtains image data for forming an electrostatic latent image. The image reading section 20 includes a sheet feed device 21, a scanner 22, a CCD sensor 23, and an image processing section 24.

The image forming section 30 includes four image forming units 31 corresponding to respective colors of, for example, yellow, magenta, cyan, and black. The image forming unit 31 includes a photoreceptor (electrophotographic photoreceptor) 32, a charging device 33, an exposure device 34, a developing device 35, and a cleaning device 36.

The photoreceptor 32 is a negatively charged organic photoreceptor having photoconductivity. The photoreceptor 32 is charged by the charging device 33. The charging device 33 is a contact-type charging device that charges the photoreceptor 32 by bringing a contact charging member, such as a charging roller or a charging brush, into contact with the photoreceptor, and is, for example, a contact-type charging device that charges photoreceptor with a charging roller by contact charging. In such a contact-type charging device, it is difficult to increase the amount of the charge transport material that can be contained in the protective layer in order to maintain the strength of the protective layer. For this reason, movement of charges from the photosensitive layer to the protective layer is suppressed, and in particular, charges (typically, electrons) after transfer are less likely to be discharged from the protective layer side and are more likely to remain inside the photoreceptor to cause transfer memory. Therefore, in the present embodiment, it is possible to suppress the occurrence of transfer memory by making it easier to discharge charges after transfer to the conductive support side through the intermediate layer.

In the present embodiment, the photoreceptor 100 described above is used as the photoreceptor 32 in FIG. 2.

The exposure device 34 irradiates the charged photoreceptor 32 with light to form an electrostatic latent image. The exposure device 34 is, for example, a semiconductor laser. The developing device 35 forms a toner image corresponding to the electrostatic latent image by supplying toner to the photoreceptor 32 on which the electrostatic latent image is formed. The developing device 35 is, for example, a known developing device in an electrophotographic image forming apparatus. The cleaning device 36 removes residual toner on the photoreceptor 32. Herein, the “toner image” refers to a state in which toner is aggregated in an image shape.

As the toner, a known toner can be used. The toner may be a mono-component developer or a two-component developer. The mono-component developer is composed of toner particles. The two-component developer is composed of toner particles and carrier particles. The toner particles are composed of toner base particles and an external additive such as silica attached to the surface of the toner base particles. The toner base particles are composed of, for example, a binder resin, a coloring agent, and a wax.

The intermediate transfer section 40 includes a primary transfer unit 41 and a secondary transfer unit 42.

The primary transfer unit 41 includes an intermediate transfer belt 43, a primary transfer roller 44, a backup roller 45, a plurality of first support rollers 46, and a cleaning device 47. The intermediate transfer belt 43 is an endless belt. The intermediate transfer belt 43 is stretched by a backup roller 45 and first support rollers 46. When at least one of the backup roller 45 and the first support rollers 46 is driven to rotate, the intermediate transfer belt 43 travels on the endless track in one direction at a constant speed.

The secondary transfer unit 42 includes a secondary transfer belt 48, a secondary transfer roller 49, and a plurality of second support rollers 50. The secondary transfer belt 48 is an endless belt. The secondary transfer belt 48 is stretched by the secondary transfer roller 49 and the second support rollers 50.

The fixing device 60 includes a fixing belt 61, a heating roller 62, a first pressure roller 63, a second pressure roller 64, a heater, a temperature sensor, an airflow separation device, a guide plate, and a guide roller.

The fixing belt 61 includes a base layer, an elastic layer, and a release layer that are laminated in this order. The fixing belt 61 is axially supported by the heating roller 62 and the first pressure roller 63 with the base layer on the inner side and the release layer on the outer side.

The heating roller 62 includes a rotatable aluminum sleeve and a heater disposed inside the sleeve. The first pressure roller 63 includes, for example, a rotatable core metal and an elastic layer disposed on the outer circumferential surface of the core metal.

The second pressure roller 64 is disposed to face the first pressure roller 63 via the fixing belt 61. The second pressure roller 64 is disposed so as to be capable of approaching and separating from first pressure roller 63. As a result, when the second pressure roller 64 approaches the first pressure roller 63, the second pressure roller 64 presses the elastic layer of the first pressure roller 63 via the fixing belt 61 to form a fixing nip portion, which is a contact portion with the fixing belt 61.

The airflow separation device is a device for generating an airflow from a downstream side in the movement direction of the fixing belt 61 toward the fixing nip portion to promote separation of a recording medium S from fixing belt 61.

The guide plate is a member for guiding the recording medium S having an unfixed toner image to the fixing nip portion. The guide roller is a member for guiding the recording medium on which the toner image is fixed from the fixing nip portion to the outside of the image forming apparatus 10.

Recording medium conveying section 80 includes three sheet feed tray units 81 and a plurality of registration roller pairs 82. In the sheet feed tray unit 81, at least one recording medium S (standard paper, special paper, and the like in the present embodiment) identified based on basis weight, size, and the like are accommodated for each type set in advance. The registration roller pairs 82 are disposed so as to form a desired conveyance path.

In such an image forming apparatus 10, first, the photoreceptor 32 electrically charged by the contact with charging roller is irradiated with light to form an electrostatic latent image, and then toner is supplied to the surface of the photoreceptor 32 to form a toner image corresponding to the electrostatic latent image. In the intermediate transfer section 40, the toner image is transferred to the recording medium S sent by the recording medium conveying section 80. The toner image transferred onto the recording medium S in the intermediate transfer section 40 is fixed to the recording medium S by the fixing device 60. The recording medium on which the toner image is fixed is guided to the outside of the image forming apparatus 10 by the guide roller. An image can be formed in this manner.

### EXAMPLE

Hereinafter, the present invention will be described more specifically, but the following description does not limit the present invention.

1 Preparation of Electrophotographic Photoreceptor

1-1. Preparation of Photoreceptor 1

A photoreceptor 1, in which an intermediate layer, a charge generation layer, a charge transport layer, and a protective layer were laminated on a conductive support in this order, was prepared according to the following procedure.

<Conductive Support>

The surface of a cylindrical aluminum support having a diameter of 30 mm was subjected to cutting processing to obtain a conductive support having a surface roughness Rz of 1.5 (μm).

<Intermediate Layer>

A mixture of the following components was subjected to a dispersion treatment for 10 hours in a batch system using a sand mill as a dispersing machine. Thereafter, the mixture was diluted twice with methanol, allowed to stand overnight, and then filtered through Rigimesh 5 μm filter manufactured by Pall Corporation to obtain an intermediate layer coating liquid.
1 part by mass of Polyamide resin (manufactured by Toray Industries, Inc., AMILAN CM8000) (AMILAN is a registered trademark of the company)
3 parts by mass of titanium oxide (manufactured by Tayca Corporation, SMT500SAS)
10 parts by mass of methanol

The intermediate layer coating liquid was applied to the surface of the conductive support by a dip coating method so as to have a dry film thickness of 2 μm, and dried to obtain an intermediate layer.

<Charge Generation Layer>

A mixture of the following components was subjected to a dispersion treatment for 10 hours using a sand mill as dispersing machine to obtain a charge generation layer coating liquid.
20 parts by mass of charge generation material (a titanyl phthalocyanine pigment: a titanyl phthalocyanine pigment having a maximum diffraction peak at least at a position of 27.3° in a Cu—Kα characteristic X-ray diffraction spectrum measurement)
10 parts by mass of polyvinyl butyral resin (manufactured by Denki Kagaku Kogyo KK., #6000-C)
700 parts by mass of t-butyl acetate
300 parts by mass of 4-methoxy-4-methyl-2-pentanone

The charge generation layer coating liquid was applied to the surface of the intermediate layer by a dip coating method so as to have a dry film thickness of 0.3 μm, and dried to obtain an charge generation layer.

<Charge Transport Layer>

The following components are stirred and mixed to obtain a charge transport layer coating liquid.
225 parts by mass of charge transport material (CTM-A)
300 parts by mass of polycarbonate resin (manufactured by MITSUBISHI GAS CHEMICAL COMPANY, INC., Z300)
6 parts by mass of an antioxidant (manufactured by BASF SE, Irganox1010)
1600 parts by mass of tetrahydrofuran
400 parts by mass of toluene
1 part by mass of silicone oil (manufactured by Shin-Etsu Chemical Co., Ltd., KF-54)

The charge transport layer coating liquid was applied to the surface of the intermediate layer by a dip coating method so as to have a dry film thickness of 20 μm and dried to obtain a charge transport layer.

<Protective Layer>

The following components are stirred and mixed to obtain a protective layer coating liquid 1.
85 parts by mass of a radically polymerizable charge transporting compound A3
10 parts by mass of silica particles surface-treated with a surface treating agent (manufactured by Shin-Etsu Chemical Co., Ltd., KF9908) having a silicone chain in a side chain
5 parts by mass of polymerization initiator (manufactured by IGM Resins B. V, Ominirad 819)
350 parts by mass of tetrahydrofuran
   150 parts by mass of 2-butanol

The protective layer coating liquid 1 was applied onto the surface of the charge transport layer by using a circular slide hopper coater. Thereafter, the applied protective layer coating liquid 1 was irradiated with ultraviolet rays (wavelength 385 nm) from a xenon lamp for 1 minute to obtain a protective layer having a dry thickness of 3.0 μm.

1-2. Preparation of Photoreceptor 2

A photoreceptor 2 was obtained in the same manner as the photoreceptor 1 except the following: protective layer coating liquid 2, which is prepared in the same manner as protective layer coating liquid 1 except that no polymerization initiator is added, is used instead of protective layer coating liquid 1; and a protective layer having a dry film thickness of 30 μm is obtained by irradiation with electron beams instead of ultraviolet rays.

1-3. Preparation of Photoreceptor 3 to Photoreceptor 13

Photoreceptors 3 to 13 were obtained in the same manner as the photoreceptor 1 except that protective layer coating liquids 3 to 13 whose compositions are described in Table 1 were used instead of protective layer coating liquid 1, respectively. As described in Table 1, in the preparation of the photoreceptor 8, a protective layer was formed using light from a mercury xenon lamp instead of ultraviolet rays.

The abbreviations described in Table 1 indicate the following compounds or products.

(Monomer)
SR350: Trimethylolpropane trimethacrylate (manufactured by Sartomer, SR350)

(Charge Transporting Compound)
A1: Compound represented by the following General Formula (4)

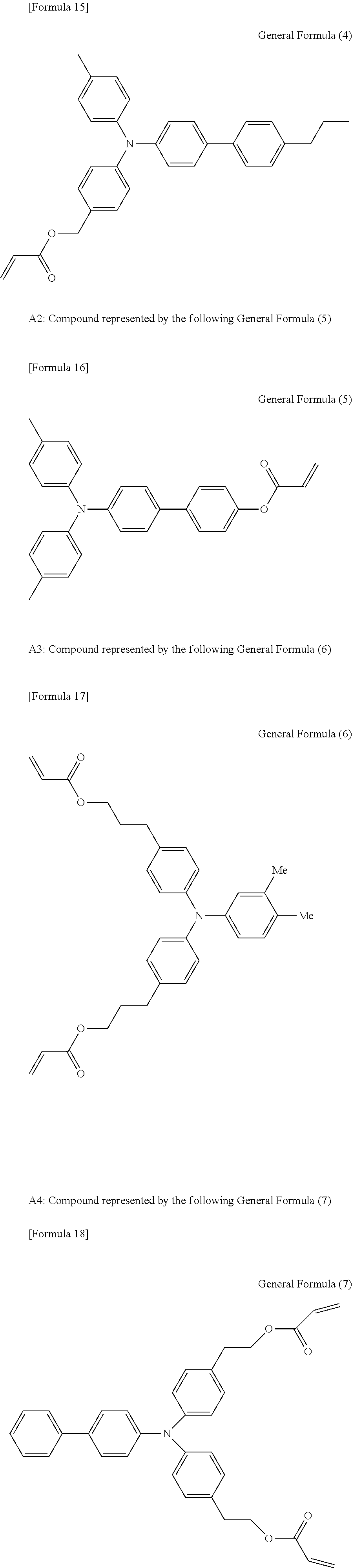

(Surface Treating Agent 1)

Surface treating agents 1 are all surface treating agents having a silicone chain in a side chain thereof.
KF9908: manufactured by Shin-Etsu Chemical Co., Ltd., KF9908 (main chain is silicone chain)
KF9909: manufactured by Shin-Etsu Chemical Co., Ltd., KF9909 (main chain is silicone chain)
KP-574: manufactured by Shin-Etsu Chemical Co., Ltd., KP-574 (main chain is (meth)acrylic copolymer)
KP-578: manufactured by Shin-Etsu Chemical Co., Ltd., KP-578 (main chain is a (meth)acrylic copolymer)

(Surface Treating Agent 2)

Surface treating agent 2 is a surface treating agent having a radically polymerizable functional group. KBM503: manufactured by Shin-Etsu Chemical Co., Ltd., KBM503 (having a methacryloyl group)

(Surface Treating Agent 3)

Surface treating agent 3 is a surface treating agent having a silicone chain in its main chain and no silicone chain in its side chain.
X-22-4105: manufactured by Shin-Etsu Chemical Co., Ltd., X-22-4105

(Polymerization Initiator)
819: manufactured by IGM Resins B. V, Ominirad819

(Curing Condition)
UV: Irradiation with ultraviolet rays (Wavelengths 385 nm) from Xenon Lamp
EB: Irradiation with electron beams
Mercury Xe: Irradiation with light from a mercury xenon lamp

TABLE 1

| | Composition of protective layer coating liquid | | | | | | | | | | | |
|---|---|---|---|---|---|---|---|---|---|---|---|---|
| | | | Charge | | | | | | | | | |
| | | | transporting | | Metal oxide | | | | | | | |
| | Monomer | | compound | | | Surface | Surface | Surface | | Initiator | | |
| | | parts by | | parts by | | treating | treating | treating | parts by | | parts by | Curing |
| | Type | mass | Type | mass | Type | agent 1 | agent 2 | agent 3 | mass | Type | mass | condition |
| Photoreceptor | — | — | A3 | 85 | Silica | KF9908 | — | — | 10 | 819 | 5 | UV |
| 1 | | | | | | | | | | | | |
| Photoreceptor | — | — | A3 | 90 | Silica | KF9908 | — | — | 10 | — | — | EB |
| 2 | | | | | | | | | | | | |
| Photoreceptor | SR350 | 40 | A1 | 45 | Silica | KF9908 | — | — | 10 | 819 | 5 | UV |
| 3 | | | | | | | | | | | | |
| Photoreceptor | SR350 | 40 | A1 | 45 | Alumina | KF9908 | — | — | 10 | 819 | 5 | UV |
| 4 | | | | | | | | | | | | |
| Photoreceptor | SR350 | 40 | A1 | 45 | Tin | KF9908 | — | — | 10 | 819 | 5 | UV |
| 5 | | | | | oxide | | | | | | | |
| Photoreceptor | SR350 | 40 | A1 | 45 | Silica | KF9909 | — | — | 10 | 819 | 5 | UV |
| 6 | | | | | | | | | | | | |
| Photoreceptor | SR350 | 40 | A1 | 45 | Silica | KP-574 | — | — | 10 | 819 | 5 | UV |
| 7 | | | | | | | | | | | | |
| Photoreceptor | SR350 | 40 | A1 | 45 | Silica | KP-578 | — | — | 10 | 819 | 5 | Mercury |
| 8 | | | | | | | | | | | | Xe |
| Photoreceptor | SR350 | 40 | A2 | 45 | Silica | KF9908 | — | — | 10 | 819 | 5 | UV |
| 9 | | | | | | | | | | | | |
| Photoreceptor | SR350 | 40 | A4 | 45 | Silica | KF9908 | — | — | 10 | 819 | 5 | UV |
| 10 | | | | | | | | | | | | |
| Photoreceptor | SR350 | 40 | A1 | 45 | Silica | KF9908 | KBM503 | — | 10 | 819 | 5 | UV |
| 11 | | | | | | | | | | | | |
| Photoreceptor | SR350 | 40 | A1 | 45 | Silica | — | KBM503 | — | 10 | 819 | 5 | UV |
| 12 | | | | | | | | | | | | |
| Photoreceptor | SR350 | 40 | A1 | 45 | Silica | — | — | X-22-4105 | 10 | 819 | 5 | UV |
| 13 | | | | | | | | | | | | |

2 Evaluation

Each of the photoreceptors 1 to 13 was installed in a color multifunction peripheral “bizhub C650i” (manufactured by Konica Minolta, Inc.) equipped with a commercially available charging roller process. Durability tests, in each of which a text image having an image area ratio of 6% was printed successively on both sides of each of 500,000 A4 sheets which were fed transversely, were conducted independently under different environmental conditions using the multifunction peripherals in which photoreceptors were respectively installed. Before and after the durability test, the following evaluations were performed.

2-1: Starting Torque of Cleaning Blade (Initial Stage, after Durability Test)

Before the durability test (initial stage) and after the durability test in an environment of 23° C. and 50% RH, a torque gauge (MODEL 6BTG manufactured by Tohnichi Manufacturing Co., Ltd.) connected to the drum-shaft of a photoreceptor was rotated to measure the static torque of the photoreceptor. The measurement was performed five times, and the average value thereof was taken as the value of torque.
A: The measured torque value was 1.0 kgf·cm or less
B: The measured torque value was more than 1.0 kgf·cm and 2.0 kgf·cm or less
C: The measured torque value was 2.0 kgf·cm or more

2-2. Image Deletion (after Durability Test)

Immediately after the durability test in a 30° C. and 85% RH environment (high-temperature, high-humidity environment), a main power source of the color multifunction peripheral was stopped. After 12 hours from the stop, the color multifunction peripheral was turned on, and immediately after the color multifunction peripheral became a printable state, a halftone image (relative reflection density of 0.4 by a Macbeth densitometer) was printed on the entire surface of A3 neutral paper, and a 6 dot lattice image was printed on the entire surface of A3 neutral paper. The state of each printed image was visually observed, and evaluations were performed as follows.
A: Both the halftone image and the lattice image did not have a decrease in density for each portion
B: A thin band-like density decrease in the longitudinal direction of the photoreceptor was observed in the halftone image, but a density decrease in each portion was not observed in the lattice image
C: Loss of the lattice image and the thinning of the line width for each portion due to the density decrease significantly occurred

2-3. Electrical Characteristics (after a Durability Test)

After the durability test in a 10° C. and 15% RH environment (low-humidity low-temperature environment), the charging potential of the photoreceptor was set to −800 V, exposure was performed, and the surface potential of the photoreceptor after exposure was measured.
A: The surface potential after exposure was 0 V to −150 V
B: The surface potential after exposure was −150 V to −250 V
C: The surface potential after exposure was −250 V or less

Table 2 shows the results of evaluation of the photoreceptors 1 to 13.

TABLE 2

| | Evaluation | | | |
|---|---|---|---|---|
| | Torque | | | |
| | Initial | After | Image | Electrical |
| | stage | endurance | deletion | characteristics |
| Photoreceptor 1 | A | B | B | A |
| Photoreceptor 2 | A | B | B | A |
| Photoreceptor 3 | A | A | A | A |
| Photoreceptor 4 | A | A | A | B |
| Photoreceptor 5 | A | A | A | B |
| Photoreceptor 6 | A | A | A | A |
| Photoreceptor 7 | A | A | A | A |
| Photoreceptor 8 | A | A | A | A |
| Photoreceptor 9 | A | B | B | A |
| Photoreceptor 10 | B | B | B | A |
| Photoreceptor 11 | A | A | A | A |
| Photoreceptor 12 | C | C | C | B |
| Photoreceptor 13 | B | C | C | B |

As illustrated in Tables 1 and 2, when the protective layer was formed with the cured product of the composition containing the charge transporting compound having a radically polymerizable functional group and the metal oxide particle surface-treated with the surface treating agent having a silicone chain in its side chain, the rotational torque of the photoreceptor could be decreased, and the increase in the rotational torque in long-term use could also be decreased.

According to the present invention, it is possible to reduce the torque of a photoreceptor and enhance the durability of the photoreceptor. The present invention is expected to contribute to further spread of an image forming method using a photoreceptor.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrophotographic photoreceptor, comprising:
a conductive support;
a photosensitive layer; and
a protective layer, wherein the conductive support, the photosensitive layer, and the protective layer are laminated in this order,
wherein
the protective layer is formed of a cured product of a composition containing a charge transporting compound and a metal oxide particle, the charge transporting compound having a radically polymerizable functional group, the metal oxide particle being surface-treated with a surface treating agent having a silicone chain in a side chain thereof.

2. The electrophotographic photoreceptor according to claim 1, wherein the metal oxide particle is further surface-treated with a surface treating agent having a radically polymerizable functional group.

3. The electrophotographic photoreceptor according to claim 1, wherein the charge transporting compound having the radically polymerizable functional group is a compound represented by General Formula (1) below: 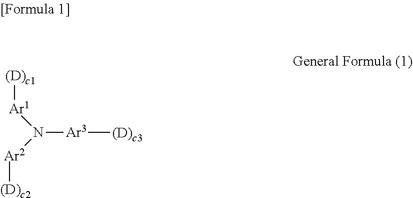
wherein
Ar¹ and Ar² independently represent a structure represented by General Formula (2) below,
Ar³ represents a structure represented by General Formula (2) or General Formula (3) below,
D independently represents a structure represented by —(—(CH₂)_{d}—(O—(CH₂)_{f}—)ₑ—O—CO—C(CH₃)═CH₂) or —(—(CH₂)_{d}—(O—(CH₂)_{f}—)ₑ—O—CO—CH═CH₂), wherein d and f independently represent an integer of 0 or more and 5 or less, and e represents an integer of 0 or 1,
c1 to c3 independently represent an integer of 0, 1, or 2,
when Ar³ represents the structure represented by General Formula (2), a total number of D's in the compound is 1 or 2, and
when Ar³ represents the structure represented by General Formula (3), the total number of D's in the compound is 1: 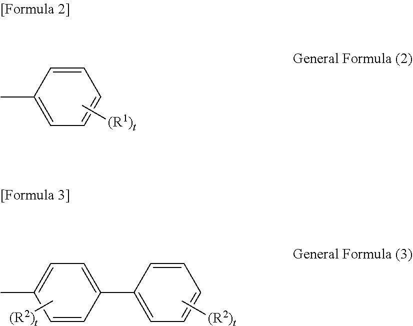
wherein
R¹ and R² independently represent a functional group or an atom selected from the group consisting of a hydrogen atom, an alkyl group having 1 or more and 4 or less carbon atoms, an alkoxy group having 1 or more and 4 or less carbon atoms, a phenyl group substituted with an alkoxy group having 1 or more and 4 or less carbon atoms, an unsubstituted phenyl group, an aralkyl group having 7 or more and 10 or less carbon atoms, and a halogen atom, wherein two R²'s in General Formula (3) are optionally bonded to each other to form a cyclic structure, and
t independently represents an integer of 1 or more and 3 or less.

4. The electrophotographic photoreceptor according to claim 3, wherein the compound represented by General Formula (1) is a compound in which Ar³ represents the structure represented by General Formula (3).

5. The electrophotographic photoreceptor according to claim 3, wherein the compound represented by General Formula (1) is a compound in which a total of c1 to c3 is 1 and, in the structure represented by D, e represents 1 and at least one of d and f represents an integer of 1 or more and 4 or less.

6. The electrophotographic photoreceptor according to claim 1, wherein the metal oxide particle is a silica particle.

7. An image forming apparatus, comprising the electrophotographic photoreceptor according to claim 1.

8. An image forming method, comprising:
charging a surface of the electrophotographic photoreceptor according to claim 1 by bringing a charging roller into contact with the electrophotographic photoreceptor;
applying toner to the surface of the electrophotographic photoreceptor, the surface being charged; and
transferring the toner applied to a recording medium.
